(19) United States
(12) Patent Application Publication
(10) Pub. No.: US 2018/0230976 A1
(43) Pub. Date: Aug. 16, 2018

(54) WATER-TRIGGERED ENERGY TRANSFORMATION SYSTEM

(71) Applicants: Jen Chang Tsai, Walnut, CA (US); Luxia Ma, Monterey Park, CA (US); Sousa Chen, Walnut, CA (US); Shyi Yuan Chen, Diamond Bar, CA (US); Yun Yuan Chu, New Taipei City (TW); Jing Hua Xiao, Diamond Bar, CA (US); Feng Yu, Buena Park, CA (US); Yu Fu Cheng, Arcadia, CA (US)

(72) Inventors: Jen Chang Tsai, Walnut, CA (US); Luxia Ma, Monterey Park, CA (US); Sousa Chen, Walnut, CA (US); Shyi Yuan Chen, Diamond Bar, CA (US); Yun Yuan Chu, New Taipei City (TW); Jing Hua Xiao, Diamond Bar, CA (US); Feng Yu, Buena Park, CA (US); Yu Fu Cheng, Arcadia, CA (US)

(73) Assignee: Jen Chang Tsai, Walnut, CA (US)

(21) Appl. No.: 15/893,580

(22) Filed: Feb. 9, 2018

Related U.S. Application Data
(60) Provisional application No. 62/457,118, filed on Feb. 9, 2017.

(51) Int. Cl. F03G 7/10

(52) U.S. Cl. CPC F03G 7/10

(57) ABSTRACT

A water-triggered energy transformation system may include a water transportation assembly and an energy transformation assembly, wherein the water transportation assembly includes a water inlet, a water tank, a plurality of water pump, and water pipelines to transport the water from the water tank to a water outlet; and the energy transformation assembly includes a water turbine with a plurality of magnets thereon, a pair of magnetic control switches, a plurality of electromagnetic coils, a plurality of magnets, and a plurality of LED lighting fixtures. Clean water flows into the system from the water inlet and then flows to the water tank, and the water can be lifted by the water pumps to the water outlet to drive the water turbine to cause the magnets thereon to change positions to further trigger the magnetic control switches and electromagnetic coils to generate electric current to power the LED lighting fixtures.

### CROSS-REFERENCE TO RELATED APPLICATIONS

This application claims priority under 35 U.S.C. § 119 (e) to U.S. Provisional Patent Application Ser. No. 62/457,118, filed on Feb. 9, 2017, the entire contents of which are hereby incorporated by reference.

### FIELD OF THE INVENTION

The present invention relates to an energy transformation system, and more particularly to a water-triggered energy transformation system that can be used to trigger photosynthesis to enable plants to grow in an isolated tank and provide sufficient oxygen for animals therein.

### BACKGROUND OF THE INVENTION

It is known that magnetic force has been proven existed and widely used to magnetize various kinds of substances to change their molecular structure and physical properties. For example, when the magnetic force is used to magnetize water, the magnetic force is in a direction perpendicular to the direction of water flow, so that the magnetic lines of the magnetic force repeatedly cut through the water flow to eventually change the molecular structure and physical properties of the water to possibly make the water taste better.

Magnetic force can also be used for water purification. For example, U.S. Pat. No. 5,628,900 to Naito discloses a water purifier including a filter having a cylindrical housing formed with a water inlet at one end and a water outlet on the other end and containing a granular activated carbon layer and a ceramic layer comprising granular ceramic, a magnetite layer comprising broken pieces of magnetite in a layer and provided at least above or below the ceramic layer, and annular magnets provided above and below the ceramic layer in such a manner that these annular magnets coincide with each other in the sense of magnetic lines of force and that the direction of the magnetic lines of force is parallel to the direction of flow of water. Water molecules are activated while passing through the magnetic field produced by the annular magnets and the magnetite layers which are magnetized by the annular magnets.

However, conventional means to produce the magnetic field can be more efficient. Therefore, there remains a need for a new and improved technique to more efficiently generate the magnetic field to change the molecular structure and physical properties of the water.

### SUMMARY OF THE INVENTION

In one aspect, a water-triggered energy transformation system may include a water transportation assembly and an energy transformation assembly. In one embodiment, the water transportation assembly may include a water inlet, a water tank, a plurality of water pump, and water pipelines to transport the water from the water tank to a water outlet. The energy transformation assembly may include a water turbine with a plurality of magnets thereon, a pair of magnetic control switches, a plurality of electromagnetic coils, a plurality of magnets disposed in corresponding positions, and a plurality of LED lighting fixtures.

In an exemplary embodiment, clean water flows into the water-triggered energy transformation system in the present invention from the water inlet and then flows to the water tank, and the water can be lifted by the water pumps to the water outlet to drive the water turbine to cause the magnets thereon to change positions which can further trigger the magnetic control switches and the electromagnetic coils to generate electric current to power the LED lighting fixtures. It is noted that two magnetic fields can be generated in the system, wherein the first magnetic field can be continuously generated by the magnets on the turbine, and two magnets on the same side and below the water inlet. The first and second magnetic fields along with the light emitted by the LED lighting fixtures can trigger photosynthesis of plants (not shown) in the water tank to enable the plants to grow in the water tank and may provide sufficient oxygen for animals like fishes (not shown) therein.

In another aspect, the water-triggered energy transformation system in the present invention can be used as an air purifying system, which may further include a fan and an air filter located above the water tank. As discussed above, the water can flow out from the water outlet to drive the water turbine to continuously generate the first magnetic field, which can activate the water molecules near or on the air filter to purify the air driven by the fan passing through the air filter.

In a further aspect, the water-triggered energy transformation system in the present invention can be used as an air cooling system. An air cooler is disposed near the water turbine, so the water temperature can be lowered by the air cooler when it hit the water turbine. When the water goes down through the pipelines, the air passing through the water pipelines can also be cooled down and blew out by the fan.

### BRIEF DESCRIPTION OF THE DRAWINGS

FIG. 1 is a schematic view of the water-triggered energy transformation system in the present invention.

FIG. 2 is a schematic view of water circulation of the water-triggered energy transformation system in the present invention.

FIG. 3 is a schematic view of the water-triggered energy transformation system in the present invention with plants therein.

FIG. 4 is a circuit diagram of the water-triggered energy transformation system in the present invention.

FIG. 5 is a schematic view of the water-triggered energy transformation system used as an air purifying system in the present invention.

FIG. 6 is a schematic view of the water-triggered energy transformation system used as an air cooling system in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

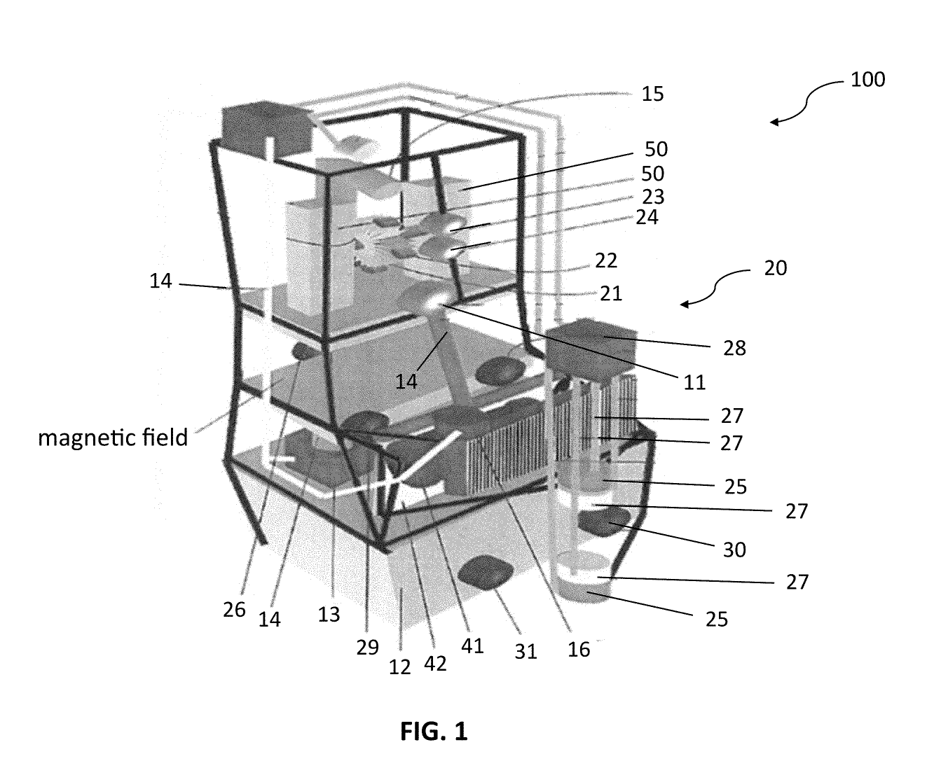

In one aspect, as shown in FIG. 1, a water-triggered energy transformation system 100 may include a water transportation assembly 10 and an energy transformation assembly 20. In one embodiment, the water transportation assembly 10 may include a water inlet 11, a water tank 12, a plurality of water pump 13 powered by a power source 16, and water pipelines 14 to transport the water from the water tank 13 to a water outlet 15. The energy transformation assembly 20 may include a water turbine 21 with a plurality of magnets 22 thereon, a pair of magnetic control switches (23, 24), a plurality of electromagnetic coils 25, a plurality of magnets 26 disposed in corresponding positions, and a plurality of LED lighting fixtures 27.

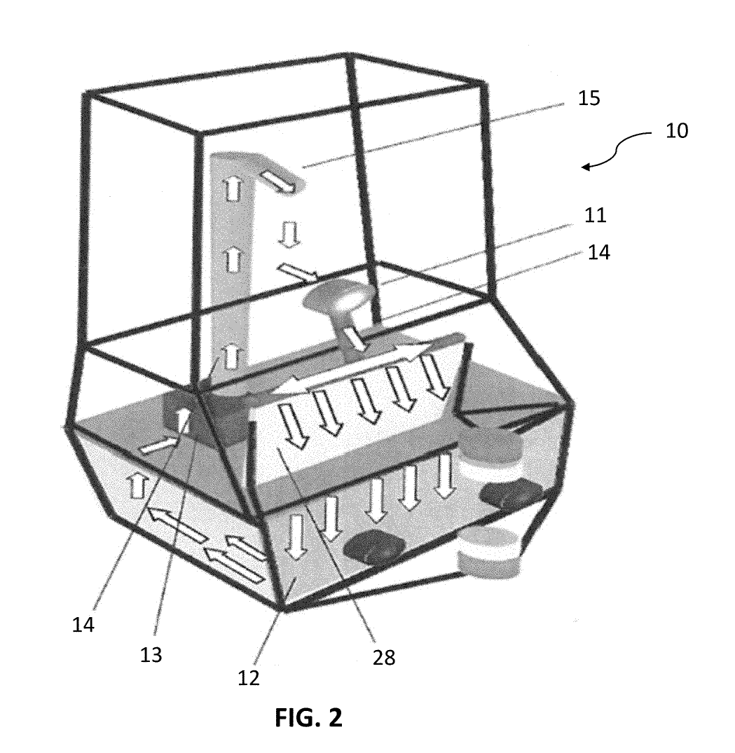

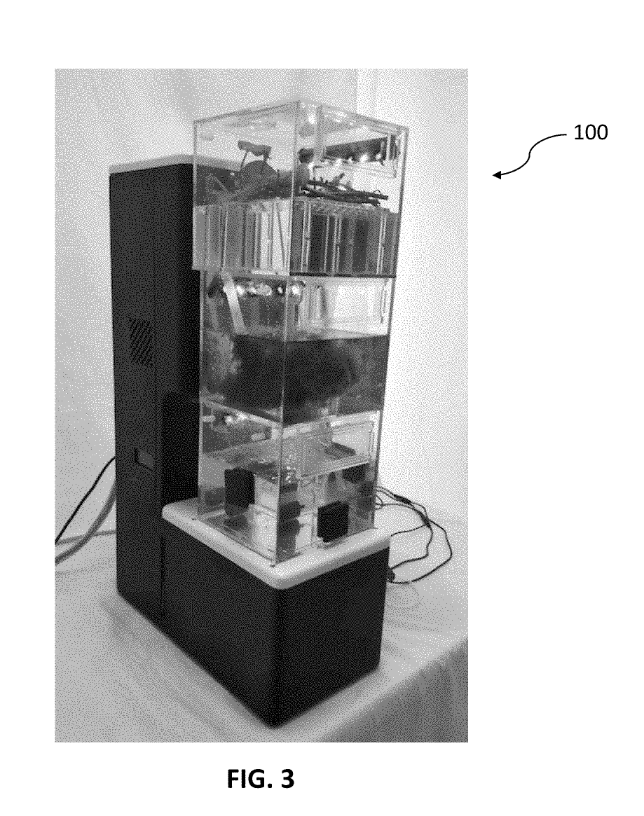

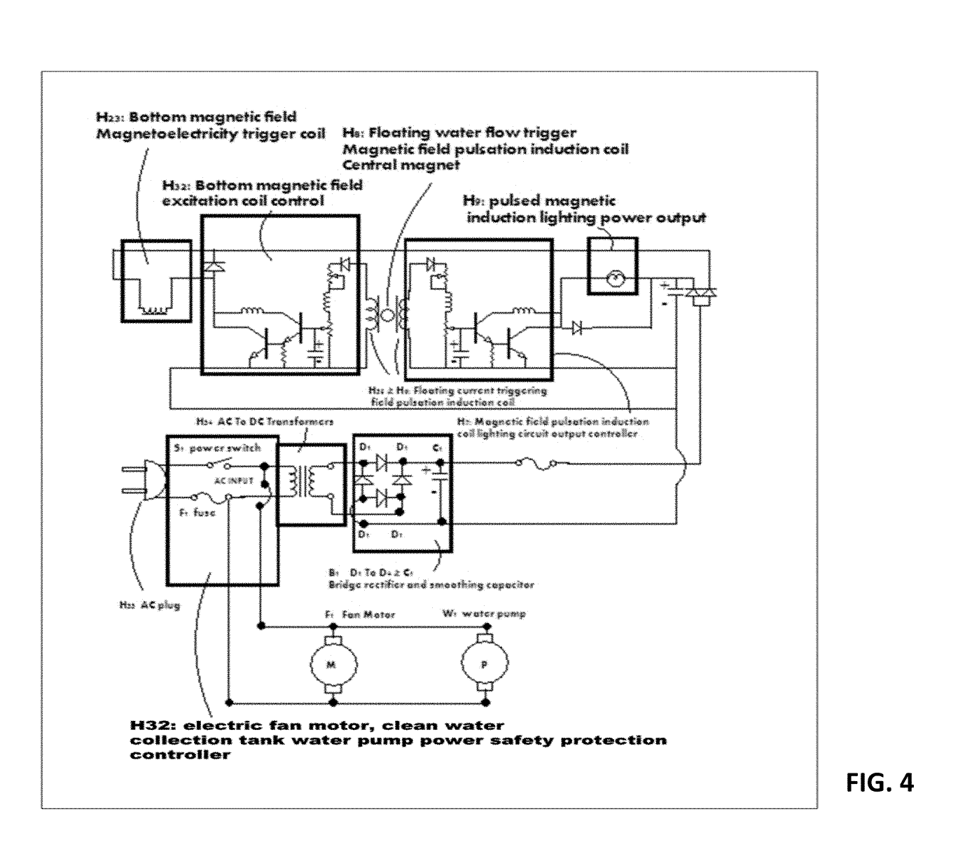

In an exemplary embodiment, clean water flows into the water-triggered energy transformation system in the present invention from the water inlet 11 and then flows to the water tank 12, and the water can be lifted by the water pumps 13 to the water outlet 15 to drive the water turbine 21 to cause the magnets 22 thereon to change positions which can further trigger the magnetic control switches (23, 24) and the electromagnetic coils 25 to generate electric current to power the LED lighting fixtures 27. It is noted that two magnetic fields can be generated in the system, wherein the first magnetic field can be continuously generated by the magnets 22 on the turbine 21, and two magnets 28 and 29 on the same side and below the water inlet 11. The second magnetic field can be generated between magnets (28, 29) and magnets (30, 31) therebelow. The first and second magnetic fields along with the light emitted by the LED lighting fixtures 27 can activate the water molecules in the water tank 12 and trigger photosynthesis of plants to grow therein (as shown in FIG. 3) and may provide sufficient oxygen for animals like fishes (not shown) therein. The circulation of water in the water-triggered energy transformation system 100 is shown in FIG. 2 and the circuit diagram of the system can be found in FIG. 4.

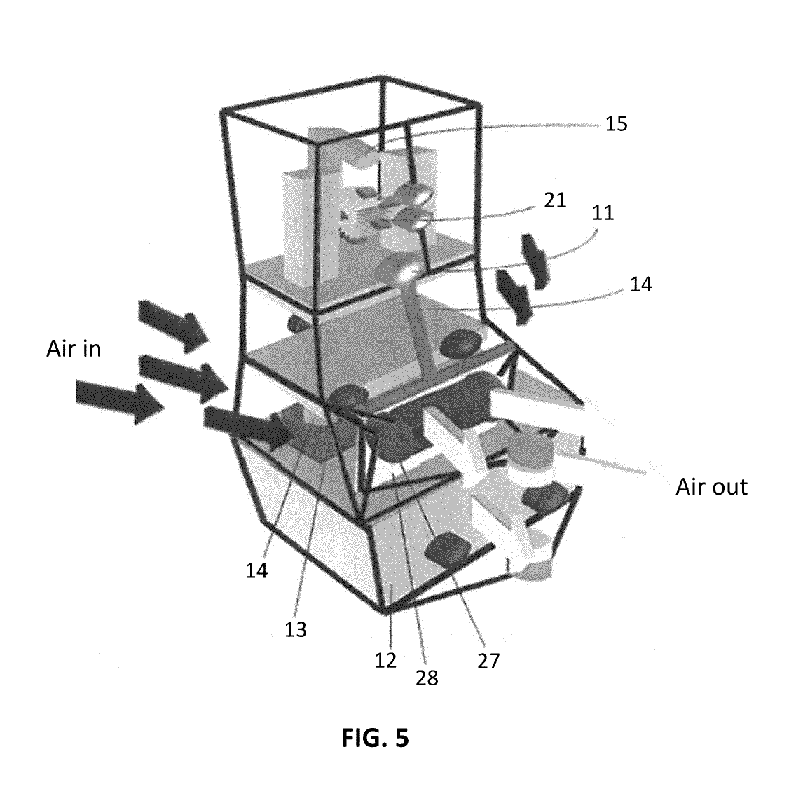

In another aspect, the water-triggered energy transformation system in the present invention can be used as an air purifying system. As shown in FIG. 5, the system 100 may further include a fan 41 and an air filter 42 located above the water tank 12. As discussed above, the water can flow out from the water outlet 15 to drive the water turbine 21 to continuously generate the first magnetic field, which can activate the water molecules near or on the air filter 42 to purify the air driven by the fan 41 passing through the air filter 42.

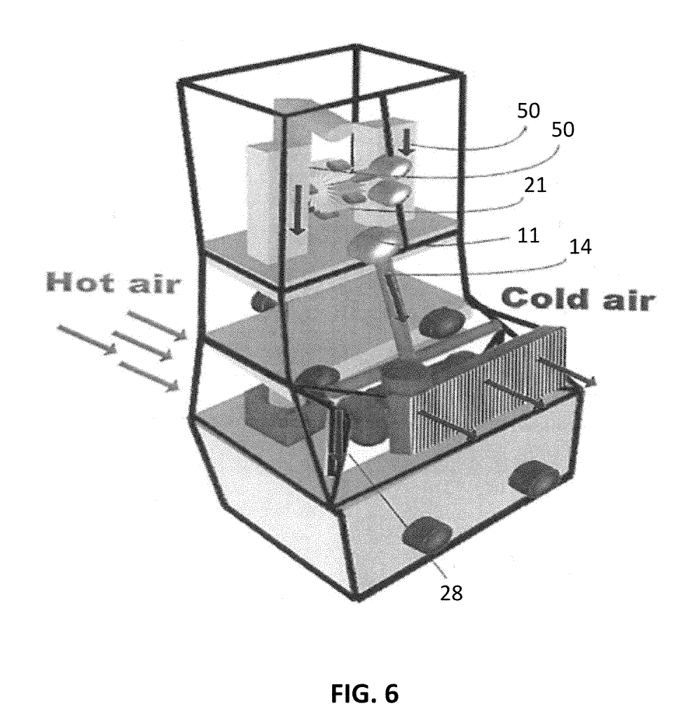

In a further aspect, the water-triggered energy transformation system in the present invention can be used as an air cooling system as shown in FIG. 6. An air cooler 50 is disposed near the water turbine 21, so the water temperature can be lowered by the air cooler 50 when it hit the water turbine 21. When the water goes down through the pipelines 14, the air passing through the water pipelines 14 can also be cooled down and blew out by the fan 41.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A water-triggered energy transformation system comprising a water transportation assembly and an energy transformation assembly, wherein the water transportation assembly includes a water inlet, a water tank, a plurality of water pump, and water pipelines to transport the water from the water tank to a water outlet; and the energy transformation assembly includes a water turbine with a plurality of magnets thereon, a pair of magnetic control switches, a plurality of electromagnetic coils, a plurality of magnets disposed in corresponding positions, and a plurality of LED lighting fixtures, wherein clean water flows into the water-triggered energy transformation system from the water inlet and then flows to the water tank, and the water can be lifted by the water pumps to the water outlet to drive the water turbine to cause the magnets thereon to change positions which can further trigger the magnetic control switches and the electromagnetic coils to generate electric current to power the LED lighting fixtures.

2. The water-triggered energy transformation system of claim 1, wherein a first magnetic field can be continuously generated by the magnets on the turbine, and two magnets on the same side and below the water inlet and a second magnetic field can be generated by the magnets nearby; the first and second magnetic fields along with the light emitted by the LED lighting fixtures can trigger photosynthesis of plants in the water tank to enable the plants to grow and generate oxygen therein.
